(19) United States
(12) Patent Application Publication
(10) Pub. No.: US 2009/0150882 A1
(43) Pub. Date: Jun. 11, 2009

(54) System and method for software application installation

(76) Inventors: Zak Dechovich, (US); Yossi Koren, (US)

Correspondence Address: Professional Patent Solutions, P.O. BOX 654, HERZELIYA PITUACH, 46105, IL

(21) Appl. No.: 11/953,888

(22) Filed: Dec. 11, 2007

(51) Int. Cl. G06F 9/445

(52) U.S. Cl. 717/178

(57) ABSTRACT

Disclose is a method and system for software installation based on an installation profile indicator. A software installation system server may store or be functionally associated with sets of related software application image blocks in a software image repository. The repository may include a single image file (“unified image” or “global image”), which unified image may include a set of software components organized and stored as a set of image blocks.

### FIELD OF THE INVENTION

The present invention relates generally to the field of computing. More specifically, the present invention relates to a method and system for software application or operating system and application installation.

### BACKGROUND

Computer and computer networks have become essential tools for business. Enterprise level computer systems and/or computer networks are deployed in most enterprises and are used in almost every aspect an enterprise, ranging from work-product production to billing and collections. Since different members of an enterprise perform different tasks, and since there is a cost (e.g. Information system management time and money) and security issue associated with providing an enterprise member with a computer/workstation loaded with computer applications, it is preferable not to provide each computer/workstation with all the application the enterprise uses. It is preferred to provide each enterprise member with a computer/workstation including only those applications relevant to the tasks the member performs within the enterprise.

Computer/workstation deployment and application installation constitutes a large portion of the work performed by an Information Technologies (“IT”) person within an enterprise. In order to make the process of deployment and/or installation more efficient, IT departments within enterprises have in the past compiled sets of installation packages, where each is package is specifically compiled for a given role/position in the organization. For example, there would be a single package for secretaries, one for managers, one for engineers, etc. . . .

Although the above mentioned method may reduce computer/workstation deployment time, compiling and maintaining and managing up-to-date packages comes with its own drawbacks. It would be useful, therefore, to have an improved method and technology for deploying and installing applications on computer/workstations.

### SUMMARY OF THE INVENTION

The present invention is a method and system for installing one or more software applications, including an operating system, based on an installation profile indicator. According to some embodiments of the present invention, a target client computer (“client” or “target client device”) may be associated with an installation profile indicator.

According to some embodiments of the present invention, an installation system may include: (1) an installation server, (2) an image repository, (3) an image generator and (4) one or more target client computers.

According to some embodiments of the present invention, installation server may connect over a distributed network (e.g. internet) and/or over a local connection to an image repository.

According to yet further embodiments of the present invention, a client computer may connect over a distributed network or over a local connection to an installation server. According to some embodiments of the present invention, client target may be adapted to exchange information with the installation server related to (1) the application components installed on it, (2) an installation profile associated with it and (3) the application image blocks stored in the repository.

According to some embodiments of the present invention, an installation profile and/or an installation profile indicator (“indicator”) may be functionally associated with a target client. According to further embodiments of the present invention, an installation profile and/or an installation profile indicator may be exchanged between the client and the installation server.

According to some embodiments of the present invention, a software installation system server may store a set of installation profiles and may store lists of profile components. According to some embodiments of the present invention, an installation profile may be associated with a single list of profile components. According to further embodiments of the present invention, a list of profile components may include: a set of applications and a set of specific target components. A specific target components may be any data related to an application(s) (i.e. file, registry value, memory block etc.) which isn't a default portion of the application, some exemplary specific target components are: (1) a configuration file, (2) a registry value with a non-default value, or (3) data created by the user (i.e. a picture which was added or chosen by the user, driver code segment etc.). According to yet further embodiments of the present invention, the software installation system server may be adapted to look-up a list of profile components based on a given installation profile.

According to some embodiments of the present invention, the installation server may include an installation management module, which installation management module may be adapted to (1) receive an installation profile and/or an indicator (2) search data stored on a profile configuration data-base and (3) retrieve a list of profile components associated with the received indicator.

According to some embodiments of the present invention, the installation server may include a profile configuration data-base, which profile configuration data-base may be adapted to store lists of profile components. According to some embodiments of the present invention, each list profile components may be associated with an installation profile and/or indicator.

According to some embodiments of the present invention, the installation server may determine which image blocks are associated with the retrieved list of profile components. According to some further embodiments of the present invention, the installation server may be adapted to initiate a transfer of image blocks from the image repository to the target client.

According to some embodiments of the present invention, the client computer may be adapted to (1) receive image blocks from the Image repository and/or from the communication module and (2) install the image blocks. According to some embodiments of the present invention, the client computer may be further adapted to (1) receive a list of image blocks associated with indicated profile and (2) request from the image repository image blocks associated with the received list.

According to some embodiments of the present invention, a software installation system server may store sets of related software application image blocks in a software image repository. According to some embodiments of the present invention, the software image repository may be located on the installation server. According to alternative embodiments of the present invention, the software image repository may be distributed across one more servers and/or end-users' computers functionally associated with the installation server. According to other embodiments of the present invention, the repository may be located on one or more mass storage devices (e.g. removable HD, USB storage, etc.) functionally associated with the client.

According to some embodiments of the present invention, the repository may include a single image file (“unified image” or “global image”), which unified image may include a set of software components organized and stored as a set of image blocks.

According to some embodiments of the present invention, reference image blocks associated with a given application may be generated by parsing the application's installation files. According to alternative embodiments of the present invention, a reference image block may be generated by monitoring an installation process of the given application. According to other embodiments of the present invention, an image block may be generated by collecting data from a number of client computers, and identifying the similarities and differences between them. Any method or technology for generating reference image blocks known today or to be devised in the future may be applicable to the present invention.

According to some embodiments of the present invention, an application image block may be defined as: (1) a partial or full image of a file associated with the application, (2) an image of one or more files associated with the application, (3) registry keys and values associated with the application, and (4) entries in configuration files and/or any other data associated (i.e. operating system objects) with the application. It should be clear to one of ordinary skill in the art that an Image block of a given software application may be defined and/or composed of any data which constitutes or is otherwise associated with the software application. According to further embodiments of the present invention, an image block may be normalized, i.e. with installation-specific information (e.g. installation path, environment variables, user names, and other such settings) replaced with generic variables. According to further embodiments of the present invention, relative configuration between a normalized reference image block and the installed application image block may be taken into account and the corresponding object structures and may be mapped from the reference object structure to the installed object structure. According to alternative embodiments of the present invention, an image block may be stored as absolute data, containing a true replicate image of an installed component.

According to some embodiments of the present invention, an installation server and a client computer may communicate via a distributed data network (e.g. Internet). Image block characterization data relating to applications installed on the client may be exchanged between the client and the installation server. According to some embodiments of the present invention, an application identification module on the client may identify installed applications or components associated with installed applications, and may transmit through a communication module the data associated with identified applications. The application identification module may transmit only a list of identified applications, and/or, according to further embodiments of the present invention, may derive image block characterization data for identified applications or application components and may transmit the characterization data to the installation server.

According to some embodiments of the present invention, the installation server may send to the client image block characterization data associated with applications installed on the client. The installation server may send the image block characterization data in response to a list of applications or application components sent by the client, or it may send characterization data of all applications/components image blocks stored in the repository. According to some embodiments of the present invention, the server may send characterization data of all application/component image blocks stored in the repository, the client may respond by sending back a list of image blocks required for software installation.

According to some embodiments of the present invention, the installation server may send to the client customized check procedures which may be designed to perform complex validation and/or consistency checks on data content of components. According to some embodiments of the present invention, a customized check procedure may include one or more of: (1) checking that a field in a configuration file is within its valid range, (2) checking that a specified path value really exists on the client, (3) checking that a specified resource a value points to (e.g. an IP port) is really useable, (4) checking that an application data file is consistent, and/or (5) any other check that may require application-specific knowledge.

According to some embodiments of the present invention, the characterization data may consist of: (1) checksum (such as MD5), (2) cryptographic signature, (3) file size and modification time, and/or any other file and data characterization parameter known today or to be devised in the future.

According to alternative embodiments of the present invention, if an image block sent by the server was absolute, the client computer may identify which settings are general and which are installation-specific, and may modify them accordingly.

According to some embodiments of the present invention, the installation server may be further adapted to remotely update the drivers and/or specific components of the client computer. According to some embodiments of the present invention, the client computer may be further adapted to locally update his drivers and/or specific components.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating the main components of an exemplary software installation system in accordance with some embodiments of the present invention;

FIG. 2A is a block diagram illustrating the functional building blocks of a software installation system including (1) a target client and (2) an installation server consisting of an installation management module and an image repository in accordance with some embodiments of the present invention;

FIG. 2B is a block diagram illustrating the functional building blocks of a software installation system including (1) a target client and (2) an installation server consisting of an installation management module in accordance with some embodiments of the present invention;

FIG. 2C is a block diagram illustrating the functional building blocks of a software installation system including (1) a target client associated with an image repository and (2) an installation server consisting of an installation management module in accordance with some embodiments of the present invention;

FIG. 3A is a flowchart illustrating an exemplary method by which a software installation system installs one or more software components on a client computer from the viewpoint of the client computer in accordance with some embodiments of the present invention;

FIG. 3B is a flowchart illustrating an exemplary method by which a software installation system installs one or more software components on a client computer from the viewpoint of an installation server in accordance with some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a method and system for installing one or more software applications, including an operating system, based on an installation profile indicator. According to some embodiments of the present invention, a target client computer (“client” or “target client device”) may be associated with an installation profile indicator.

According to some embodiments of the present invention, an installation system may include: (1) an installation server, (2) an image repository, (3) an image generator and (4) one or more target client computers.

According to some embodiments of the present invention, installation server may connect over a distributed network (e.g. internet) and/or over a local connection to an image repository.

According to yet further embodiments of the present invention, a client computer may connect over a distributed network or over a local connection to an installation server. According to some embodiments of the present invention, client target may be adapted to exchange information with the installation server related to (1) the application components installed on it, (2) an installation profile associated with it and (3) the application image blocks stored in the repository.

According to some embodiments of the present invention, an installation profile and/or an installation profile indicator (“indicator”) may be functionally associated with a target client. According to further embodiments of the present invention, an installation profile and/or an installation profile indicator may be exchanged between the client and the installation server.

According to some embodiments of the present invention, a software installation system server may store a set of installation profiles and may store lists of software applications. According to some embodiments of the present invention, an installation profile may be associated with a single list of software applications. According to yet further embodiments of the present invention, the software installation system server may be adapted to look-up a list of software applications based on a given installation profile.

According to some embodiments of the present invention, the installation server may include an installation management module, which installation management module may be adapted to (1) receive an installation profile and/or an indicator (2) search data stored on a profile configuration data-base and (3) retrieve a list of software applications associated with the received indicator.

According to some embodiments of the present invention, the installation server may include a profile configuration data-base, which profile configuration data-base may be adapted to store a set of lists of software applications. According to some embodiments of the present invention, each list of software applications may be associated with an installation profile and/or indicator.

According to some embodiments of the present invention, the installation server may determine which image blocks are associated with the retrieved list of software applications. According to some further embodiments of the present invention, the installation server may be adapted to initiate a transfer of image blocks from the image repository to the target client.

According to some embodiments of the present invention, the client computer may be adapted to (1) receive image blocks from the Image repository and/or from the communication module and (2) install the image blocks. According to some embodiments of the present invention, the client computer may be further adapted to (1) receive a list of image blocks associated with indicated profile and (2) request from the image repository image blocks associated with the receive list.

According to some embodiments of the present invention, a software installation system server may store sets of related software application image blocks in a software image repository. According to some embodiments of the present invention, the software image repository may be located on the installation server. According to alternative embodiments of the present invention, the software image repository may be distributed across one more servers and/or end-users' computers functionally associated with the installation server. According to other embodiments of the present invention, the repository may be located on one or more mass storage devices (e.g. removable HD, USB storage, etc.) functionally associated with the client.

According to some embodiments of the present invention, an application may be imaged using a single image block, which single image block may include a set of image blocks associated with the application and with the specific target components.

According to some embodiments of the present invention, the repository may include a single image file (“unified image” or “global image”), which unified image may include a set of software components organized and stored as a set of image blocks.

According to some embodiments of the present invention, reference image blocks associated with a given application may be generated by parsing the application's installation files. According to alternative embodiments of the present invention, a reference image block may be generated by monitoring an installation process of the given application. According to other embodiments of the present invention, an image block may be generated by collecting data from a number of client computers, and identifying the similarities and differences between them. Any method or technology for generating reference image blocks known today or to be devised in the future may be applicable to the present invention.

According to some embodiments of the present invention, an application image block may be defined as: (1) a partial or full image of a file associated with the application, (2) an image of one or more files associated with the application, (3) registry keys and values associated with the application, and (4) entries in configuration files and/or any other data associated (i.e. operating system objects) with the application. It should be clear to one of ordinary skill in the art that an Image block of a given software application may be defined and/or composed of any data which constitutes or is otherwise associated with the software application. According to further embodiments of the present invention, an image block may be normalized, i.e. with installation-specific information (e.g. installation path, environment variables, user names, and other such settings) replaced with generic variables. According to further embodiments of the present invention, relative configuration between a normalized reference image block and the installed application image block may be taken into account and the corresponding object structures and may be mapped from the reference object structure to the installed object structure. According to alternative embodiments of the present invention, an image block may be stored as absolute data, containing a true replicate image of an installed component.

According to some embodiments of the present invention, an installation server and a client computer may communicate via a distributed data network (e.g. Internet). Image block characterization data relating to applications installed on the client may be exchanged between the client and the installation server. According to some embodiments of the present invention, an application identification module on the client may identify installed applications or components associated with installed applications, and may transmit through a communication module the data associated with identified applications. The application identification module may transmit only a list of identified applications, and/or, according to further embodiments of the present invention, may derive image block characterization data for identified applications or application components and may transmit the characterization data to the installation server.

According to some embodiments of the present invention, the installation server may send to the client image block characterization data associated with applications installed on the client. The installation server may send the image block characterization data in response to a list of applications or application components sent by the client, or it may send characterization data of all applications/components image blocks stored in the repository. According to some embodiments of the present invention, the server may send characterization data of all application/component image blocks stored in the repository, the client may respond by sending back a list of image blocks required for software installation.

According to some embodiments of the present invention, the installation server may send to the client customized check procedures which may be designed to perform complex validation and/or consistency checks on data content of components. According to some embodiments of the present invention, a customized check procedure may include one or more of: (1) checking that a field in a configuration file is within its valid range, (2) checking that a specified path value really exists on the client, (3) checking that a specified resource a value points to (e.g. an IP port) is really useable, (4) checking that an application data file is consistent, and/or (5) any other check that may require application-specific knowledge.

According to some embodiments of the present invention, the characterization data may consist of: (1) checksum (such as MD5), (2) cryptographic signature, (3) file size and modification time, and/or any other file and data characterization parameter known today or to be devised in the future.

According to alternative embodiments of the present invention, if an image block sent by the server was absolute, the client computer may identify which settings are general and which are installation-specific, and may modify them accordingly.

According to some embodiments of the present invention, the installation server may be further adapted to remotely update the drivers and specific components of the client computer. According to some embodiments of the present invention, the client computer may be further adapted to locally update his drivers and specific components.

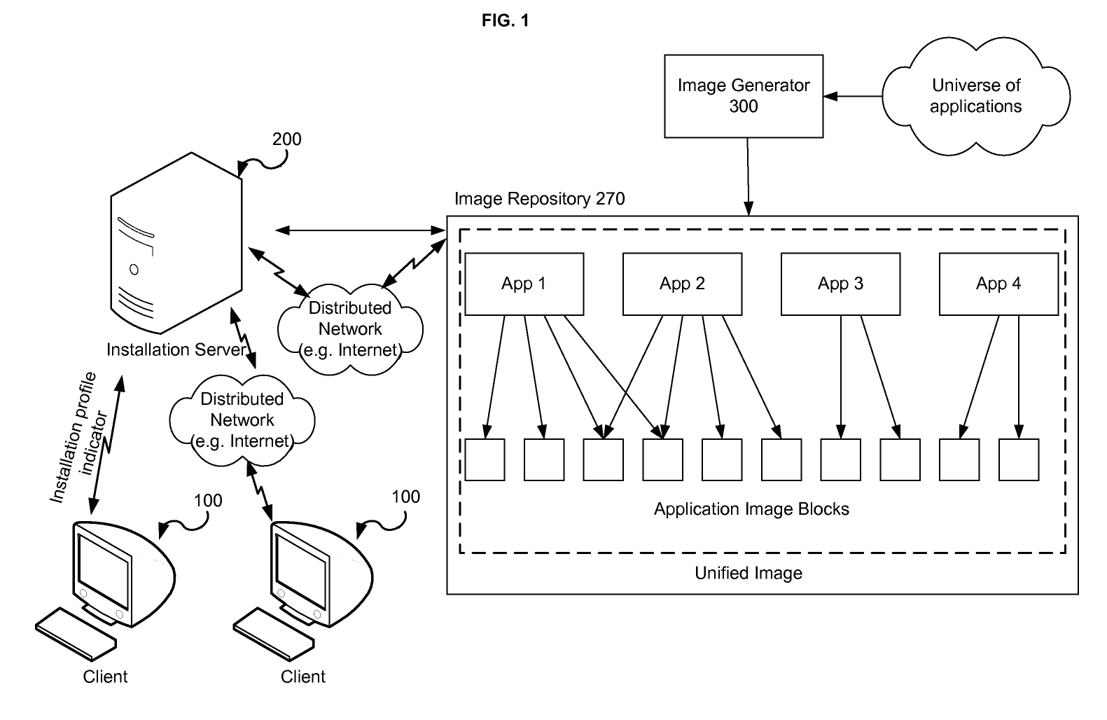

Turning now to FIG. 1, there is shown a block diagram illustrating the main components of an exemplary software installation system in accordance with some embodiments of the present invention. According to some embodiments of the present invention, an installation server 200 may be functionally associated with an image repository 270, which may be created and/or maintained by an image generator 300. According to some embodiments of the present invention, installation server 200 may connect over a distributed network (e.g. internet) and/or over a local connection with an image repository 270.

According to yet further embodiments of the present invention, a client computer 100 may connect over a distributed network or over a local connection to an installation server. According to some embodiments of the present invention, client target 100 may be adapted to exchange information with the installation server related to (1) the application components installed on it, (2) an installation profile associated with the client computer and (3) the application(s) image blocks stored in repository 270.

According to some embodiments of the present invention, repository 270 may include a single image file (“unified image” or “global image”), which unified image may include a set of software components organized and stored as a set of image blocks.

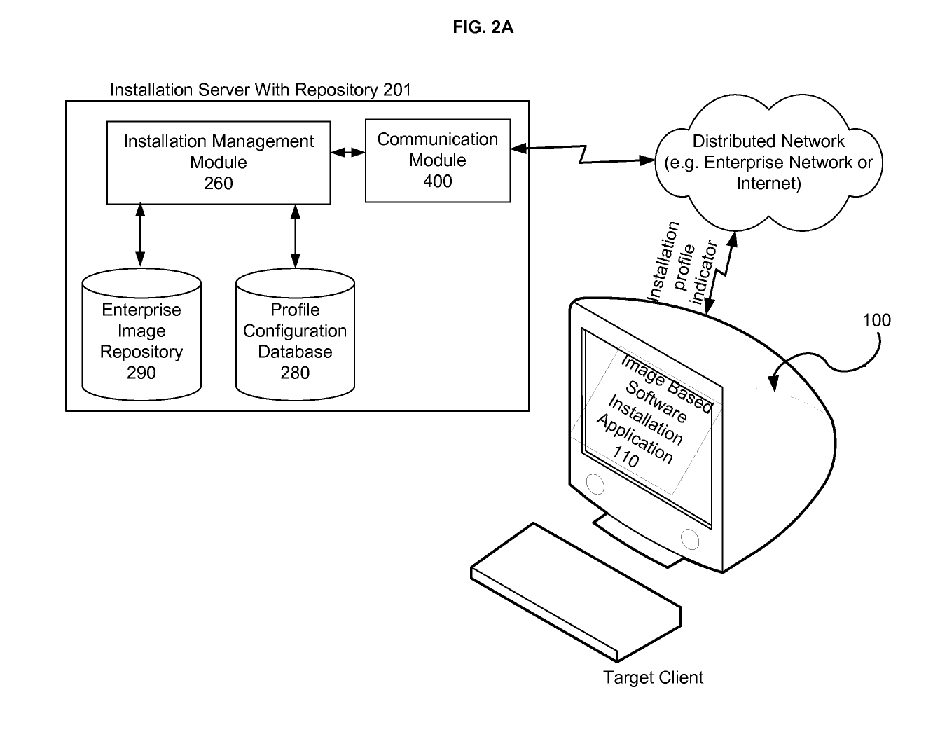

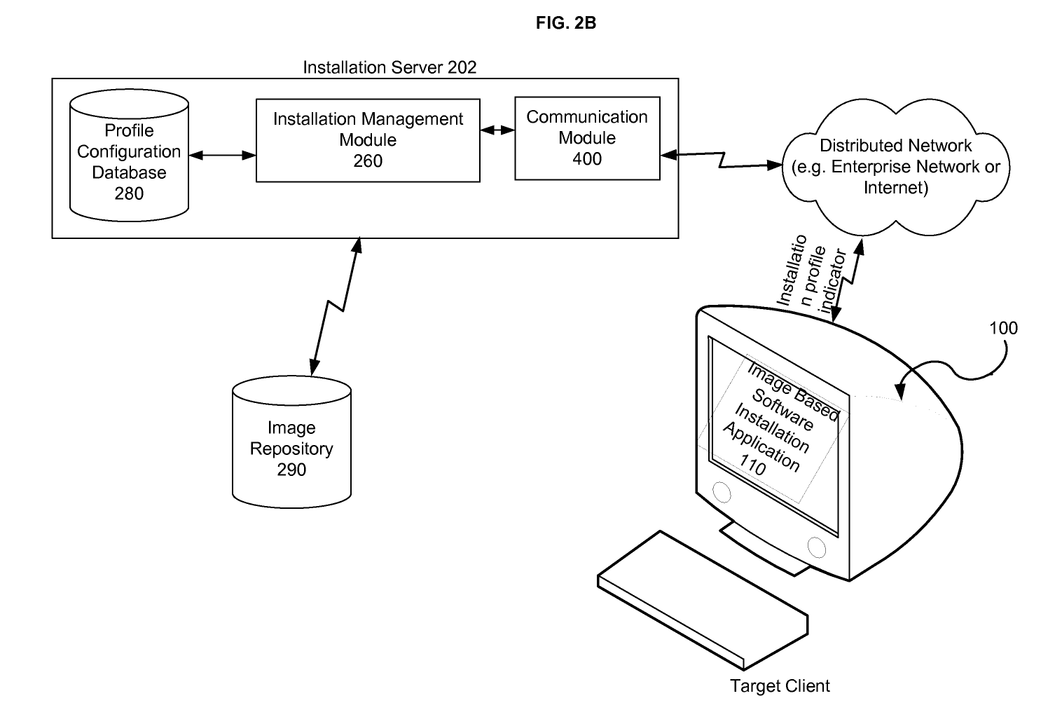

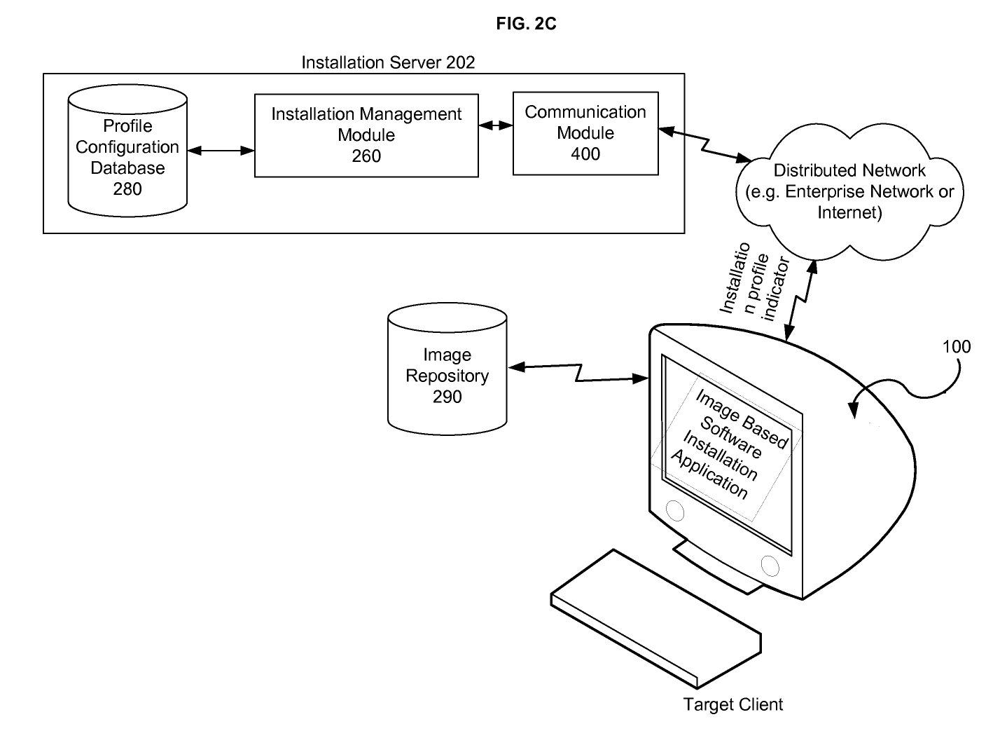

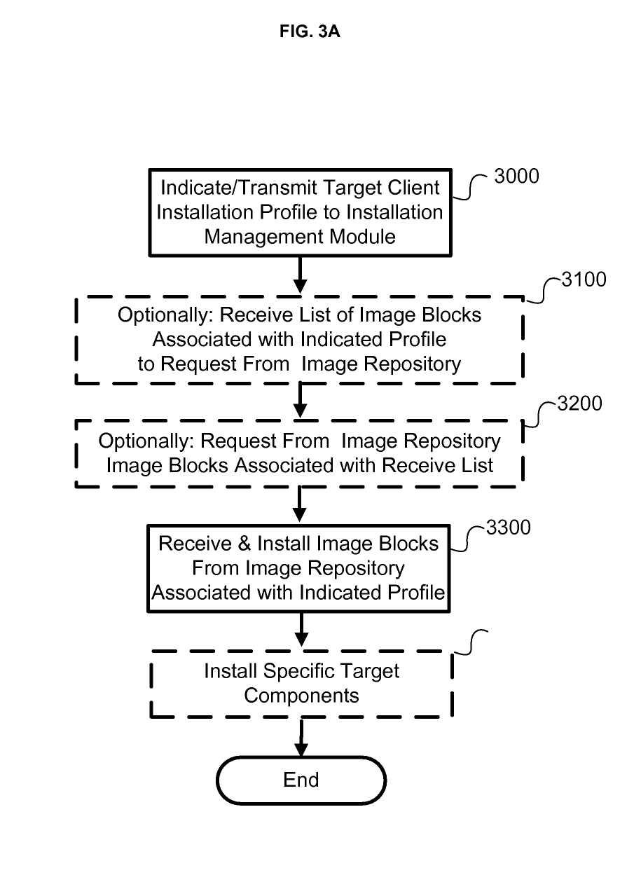

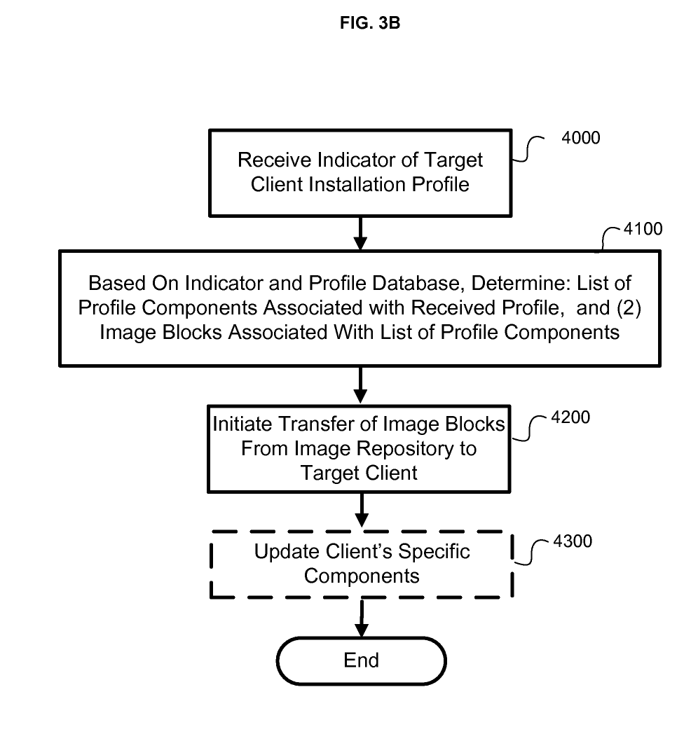

Turning now to FIG. 2A, there is shown a block diagram illustrating the functional building blocks of a software installation system including (1) a target client 100 and (2) an installation server 201. According to some embodiments of the present invention, installation server 201 may consist of (1) an installation management module 260, (2) a communication module 400, (3) a profile configuration data-base 280 and (4) an enterprise image repository 290 in accordance with some embodiments of the present invention. The functionality of the block diagram depicted in FIG. 2A may best be described in conjunction with FIGS. 3A and 3B.

According to some embodiments of the present invention, client target 100 may connect over a distributed network (e.g. enterprise network or the internet) to the installation server.

Turning now to FIG. 3A, there is shown a flowchart illustrating an exemplary method by which a software installation system installs one or more software components on a client computer from the viewpoint of the client computer in accordance with some embodiments of the present invention. According to some embodiments of the present invention, target client 100 may be adapted to indicate and/or transmit an installation profile functionally associated with target client 100 to the installation server (step 3000).

According to some embodiments of the present invention, an installation profile and/or an installation profile indicator (“indicator”) may be functionally associated with a target client 100. According to further embodiments of the present invention, an installation profile and/or an installation profile indicator may be exchanged between the client 100 and the installation server 201. According to further embodiments of the present invention, an installation profile and/or an installation profile indicator may be associated with a list of profile components. A list of profile components may include: a set of applications and a set of specific target components. According to yet further embodiments of the present invention, the set of applications and the set of specific target components may each be associated with a set of image blocks.

According to some embodiments of the present invention, target client 100 may be adapted to receive and install image block from enterprise image repository 290, which image blocks are associated with indicated profile (steps 3300 and 3400). According to some embodiments of the present invention, target client 100 may be adapted to install received image blocks using an image based software installation application 110. According to yet further embodiments of the present invention, the installation process may include two main phases:
a. Install application components (step 3300); and
b. Install and update specific target (clients) components (step 3400).

Turning now to FIG. 3B, there is shown a flowchart illustrating an exemplary method by which a software installation system installs one or more software components on a client computer from the viewpoint of an installation server 201 in accordance with some embodiments of the present invention. According to some embodiments of the present invention, installation server 201 may include: (1) a communication module 400, (2) an installation management module 260, (3) a profile configuration data-base 280 and (4) an enterprise image repository 290.

According to some embodiment of the present invention, installation server 201 may be adapted to receive an indicator of target client installation profile (step 4000).

According to some embodiment of the present invention, installation server 201 may be adapted to determine based on the received indicator: (1) a list of profile components which may include a set of software applications and a set of specific target components associated with received profile, and (2) image blocks associated with the list of profile components (step 4100).

According to some embodiments of the present invention, a software installation system server may store sets of related software application image blocks in an enterprise image repository 290. According to some embodiments of the present invention, image repository 290 may be located on the installation server. According to some embodiments of the present invention, the repository may include a single image file (“unified image” or “global image”), which unified image may include a set of software components organized and stored as a set of image blocks.

According to some embodiment of the present invention, installation server 201 may be adapted to initiate transfer of image blocks from image repository 290 to target client 100 (step 4200).

According to some embodiments of the present invention, a software installation system server may store a set of installation profiles and may store lists of profile components. According to some embodiments of the present invention, an installation profile and/or an installation profile indicator may be associated with a single list of profile components. According to yet further embodiments of the present invention, the software installation system server 201 may be adapted to look-up a list of profile components based on a given installation profile.

According to some embodiments of the present invention, the installation server may include an installation management module 260, which installation management module may be adapted to (1) receive an installation profile and/or an indicator (2) search data stored on a profile configuration data-base and (3) retrieve a list of profile components associated with the received indicator.

According to some embodiments of the present invention, installation server 201 may include a profile configuration data-base 280, which profile configuration data-base may be adapted to store a set of lists of profile components. According to some embodiments of the present invention, each list of profile components may be associated with an installation profile and/or indicator.

According to some embodiments of the present invention, installation management module 260 may determine which image blocks are associated with the retrieved list of profile components. According to some further embodiments of the present invention, installation server 201 may be adapted to initiate a transfer of image blocks from the image repository to the target client using communication module 400.

Turning now to FIG. 2B, there is shown a block diagram illustrating the functional building blocks of a software installation system including (1) a target client 100 and (2) an installation server 202. According to some embodiments of the present invention, installation server 202 may consist of (1) an installation management module 260, (2) a communication module 400, (3) and a profile configuration data-base 280. According to some embodiments of the present invention, installation server 202 may connect to an enterprise image repository 290 in accordance with some embodiments of the present invention. The functionality of the block diagram depicted in FIG. 2B may best be described in conjunction with FIGS. 3A and 3B.

According to some embodiments of the present invention, client target 100 may connect over a distributed network (e.g. enterprise network or the internet) to the installation server.

Turning now to FIG. 3A, there is shown a flowchart illustrating an exemplary method by which a software installation system installs one or more software components on a client computer from the viewpoint of the client computer in accordance with some embodiments of the present invention. According to some embodiments of the present invention, target client 100 may be adapted to indicate and/or transmit an installation profile functionally associated with target client 100 to the installation server (step 3000).

According to some embodiments of the present invention, an installation profile and/or an installation profile indicator (“indicator”) may be functionally associated with a target client 100. According to further embodiments of the present invention, an installation profile and/or an installation profile indicator may be exchanged between the client 100 and the installation server 202.

According to some embodiments of the present invention, target client 100 may be adapted to receive and install image block from enterprise image repository 290, which image blocks are associated with indicated profile (steps 3300 and 3400). According to some embodiments of the present invention, target client 100 may be adapted to install received image blocks using an image based software installation application 110. According to yet further embodiments of the present invention, the installation process may include two main phases:
a. Install application components (step 3300); and
b. Install specific target (clients) components (step 3400).

Turning now to FIG. 3B, there is shown a flowchart illustrating an exemplary method by which a software installation system installs one or more software components on a client computer from the viewpoint of an installation server 202 in accordance with some embodiments of the present invention. According to some embodiments of the present invention, installation server 202 may include: (1) a communication module 400, (2) an installation management module 260, (3) and a profile configuration data-base 280.

According to some embodiment of the present invention, installation server 202 may be adapted to receive an indicator of target client installation profile (step 4000).

According to some embodiment of the present invention, installation server 202 may be adapted to determine based on the received indicator: (1) a list of profile components associated with the received profile, and (2) image blocks associated with the list of profile components (step 4100).

According to some embodiments of the present invention, an enterprise image repository 290 may be adapted to store sets of related software application image blocks. According to further embodiments of the present invention, the enterprise image repository may be distributed across one more servers and/or end-users' computers functionally associated with the installation server. According to other embodiments of the present invention, the repository may be located on one or more mass storage devices (e.g. removable HD, USB storage, etc.) functionally associated with the installation server.

According to some embodiments of the present invention, repository 290 may include a single image file (“unified image” or “global image”), which unified image may include a set of software components organized and stored as a set of image blocks.

According to some embodiment of the present invention, installation server 202 may be adapted to initiate transfer of image blocks from image repository 290 to target client 100 (step 4200).

According to some embodiments of the present invention, a software installation system server 202 may store a set of installation profiles and may store lists of profile components. According to some embodiments of the present invention, an installation profile and/or an installation profile indicator may be associated with a single list of profile components. According to yet further embodiments of the present invention, the software installation system server 202 may be adapted to look-up a list of profile components based on a given installation profile.

According to some embodiments of the present invention, installation server 202 may include an installation management module 260, which installation management module may be adapted to (1) receive an installation profile and/or an indicator (2) search data stored on a profile configuration data-base 280 and (3) retrieve a list of profile components associated with the received indicator.

According to some embodiments of the present invention, installation server 202 may include a profile configuration data-base 280, which profile configuration data-base may be adapted to store one or more lists of profile components. According to some embodiments of the present invention, a list of profile components may be associated with an installation profile and/or indicator.

According to some embodiments of the present invention, installation management module 260 may determine which image blocks are associated with the retrieved list of profile components. According to some further embodiments of the present invention, installation server 202 may be adapted to initiate a transfer of image blocks from image repository 290 to the target client using communication module 400.

Turning now to FIG. 2C, there is shown a block diagram illustrating the functional building blocks of a software installation system including (1) a target client 100 associated with an image repository 290 and (2) an installation server 203 consisting of an installation management module 260 in accordance with some embodiments of the present invention. According to some embodiments of the present invention, target client 100 may connect to an enterprise image repository 290 in accordance with some embodiments of the present invention. The functionality of the block diagram depicted in FIG. 2C may best be described in conjunction with FIGS. 3A and 3B.

According to some embodiments of the present invention, client target 100 may connect over a distributed network (e.g. enterprise network or the internet) to installation server 203.

Turning now to FIG. 3A, there is shown a flowchart illustrating an exemplary method by which a software installation system installs one or more software components on a client computer from the viewpoint of the client computer in accordance with some embodiments of the present invention. According to some embodiments of the present invention, client target 100 may connect over a distributed network (e.g. enterprise network or the internet) to image repository 290.

According to some embodiments of the present invention, target client 100 may be adapted to indicate and/or transmit an installation profile functionally associated with target client 100 to the installation server (step 3000).

According to some embodiments of the present invention, an installation profile and/or an installation profile indicator (“indicator”) may be functionally associated with a target client 100. According to further embodiments of the present invention, an installation profile and/or an installation profile indicator may be exchanged between the client 100 and the installation server 203.

According to some embodiments of the present invention, target client 100 may be adapted to receive a list of image blocks associated with indicated profile from installation server 203 (step 3100), which installation server 203 produces the list as explained herein below.

According to some embodiments of the present invention, target client 100 may be adapted to request from enterprise image repository 290 one or more image blocks (step 3200), which image blocks may be associated with a list that was received from installation server 203.

According to some embodiments of the present invention, an enterprise image repository 290 may be adapted to store sets of related software application image blocks. According to further embodiments of the present invention, the enterprise image repository may be distributed across one more servers and/or end-users' computers functionally associated with the client 100. According to other embodiments of the present invention, the repository may be located on one or more mass storage devices (e.g. removable HD, USB storage, etc.) functionally associated with the client 100.

According to some embodiments of the present invention, target client 100 may be adapted to receive and install image blocks from enterprise image repository 290, which image blocks are associated with indicated profile (step 3300 and 3400). According to some embodiments of the present invention, target client 100 may be adapted to install received image blocks using an image based software installation application 110. According to yet further embodiments of the present invention, the installation process may include two main phases:
a. Install application components (step 3300); and
b. Install specific target (clients) components (step 3400).

Turning now to FIG. 3B, there is shown a flowchart illustrating an exemplary method by which a software installation system installs one or more software components on a client computer from the viewpoint of an installation server 203 in accordance with some embodiments of the present invention. According to some embodiments of the present invention, installation server 203 may include: (1) a communication module 400, (2) an installation management module 260, (3) and a profile configuration data-base 280.

According to some embodiment of the present invention, installation server 203 may be adapted to receive an indicator of target client installation profile (step 4000).

According to some embodiment of the present invention, installation server 203 may be adapted to retrieve, based on the received indicator: (1) a list of profile components associated with the received profile, and (2) image blocks associated with the list of profile components (step 4100).

According to some embodiment of the present invention, installation server 203 may be adapted to initiate transfer of image blocks from image repository 290 to target client 100 by sending a list of image blocks associated with a list of profile components, which list of profile components is associated with received profile and/or indicator (step 4200).

According to some embodiments of the present invention, a software installation system server 203 may store a set of installation profiles and may store lists profile components. According to some embodiments of the present invention, an installation profile and/or an installation profile indicator may be associated with a single list of profile components. According to yet further embodiments of the present invention, the software installation system server 203 may be adapted to look-up a list of profile components based on a given installation profile.

According to some embodiments of the present invention, installation server 203 may include an installation management module 260, which installation management module may be adapted to: (1) receive an installation profile and/or an indicator, (2) search data stored on a profile configuration data-base 280, and (3) retrieve a list of profile components associated with the received indicator.

According to some embodiments of the present invention, installation server 203 may include a profile configuration data-base 280, which profile configuration data-base may be adapted to store lists of profile components. According to some embodiments of the present invention, each list of profile components may be associated with an installation profile and/or indicator.

According to some embodiments of the present invention, installation management module 260 may determine which image blocks are associated with the retrieved list of profile components. According to some further embodiments of the present invention, installation server 203 may be adapted to initiate a transfer of image blocks from image repository 290 to the target client by sending a list of image blocks as explained hereinabove.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A software installation system comprising:
an installation server adapted to:
a. receive an indicator associated with an installation profile; and
b. initiate transfer of one or more image blocks based on said indicator.

2. The software installation system according to claim 1, wherein said installation server further comprises an image repository adapted to:
a. store one or more sets of related software application image blocks;

3. The software installation system according to claim 2, wherein said one or more sets of related software application image blocks are stored using a unified image file.

4. A software installation system comprising:
a client computer adapted to:
a. send an indicator associated with an installation profile; and
b. receive and install one or more image based software.

5. The software installation system according to claim 4, wherein said client computer further comprises an image repository adapted to:
a. store one or more sets of related software application image blocks;

6. The software installation system according to claim 5, wherein said one or more sets of related software application image blocks are stored using a unified image file.
